(19) United States
(12) Patent Application Publication
(10) Pub. No.: US 2016/0049088 A1
(43) Pub. Date: Feb. 18, 2016

(54) COMPUTER-BASED METHOD FOR SHARING ONLINE MUSIC EDUCATION CONTENT

(71) Applicant: MUSIC SALES DIGITAL SERVICES LLC, Chester, NY (US)

(72) Inventor: James Thomas Frankel, Chester, NY (US)

(21) Appl. No.: 14/458,129

(22) Filed: Aug. 12, 2014

(51) Int. Cl. G09B 15/00; G06F 3/0486; G06F 3/0484; H04L 29/06; G06F 3/0482

(52) U.S. Cl. CPC G09B 15/00; H04L 65/403; G06F 3/0482; G06F 3/04842; G06F 3/0486

(57) ABSTRACT

A computer-based method for sharing online music education content. The computer-based method may comprise the steps of: providing a server; wherein the server may comprise a server application configured to access a machine readable media; wherein the machine readable may store one or more music education content; wherein the one or more music education content may be one or more copyrighted music education content and one or more user generated music education content; allowing a user to preview the one or more music education content; prompting the user to select the one or more music education content; prompting the user to edit the one or more music education content; receiving one or more selections from the user; copying the one or more music education content to an online classroom based on the one or more selections of the user; and prompting the user to schedule the one or more music education content on a course schedule for at least one student.

### FIELD OF USE

This present disclosure generally relates to computer-based methods that allow a user or teacher to preview and share digital content with students. More particularly, the present disclosure generally relates to computer-based methods for utilizing an interactive website which allows teachers to preview, select, and copy music education content to a shared website page for students, and allow those teachers to assign or schedule the shared music education content.

### BACKGROUND

For dozens of years the Internet has allowed courses and class lectures to be conducted online. These courses may be beneficial to both students and instructors, as online courses provide substantial flexibility to both parties. For example, students may have the convenience to re-review lectures and access assignments on-the-go and not in real time. Additionally, instructors may be able to store class-related materials and pre-recorded lectures at a central location. When adding digital content in an online course, the instructor may also easily track the in-class progress of a particular class or student. Additionally, digital assignments may allow an educator to dynamically change his or her coursework, thereby giving instructors the flexible ability to change the class schedule without waiting for the next class meeting to make any changes.

Despite these benefits, many online courses have their drawbacks. For example, when an instructor is assigning digital coursework, the instructor may be unable to preview the coursework ahead of time, and as a result, the coursework may not be as pertinent as the instructor believed. Additionally, prior to the present disclosure online courses have been limited to providing only copyrighted content (e.g., digital print books) or user generated content (e.g., syllabus, assessments, tasks) but not both. Finally, most online courses do not utilize third party software, and are generally not directed to music education.

Thus, a need exists for a method for sharing online content for music educators, in which an instructor can preview both copyrighted and user generated content and create online music classrooms.

### SUMMARY

To minimize the limitations in the prior art, and to minimize other limitations that will become apparent upon reading and understanding the present disclosure, the present specification discloses new and useful computer-based method for sharing content online.

One embodiment may be a computer-based method for sharing online music education content, the steps comprising: providing a server; wherein the server comprises a server application configured to access a machine readable media; wherein the machine readable media is configured to store one or more music education content; allowing a user to preview the one or more music education content; prompting the user to select the one or more music education content; receiving one or more selections from the user; and copying the one or more music education content to an online classroom based on the one or more selections of the user. The one or more music education content may be one or more copyrighted music education content. The one or more copyrighted music education content may be one or more online textbooks converted from one or more print books. The one or more music education content may be one or more user generated music education content. The one or more user generated music education content may be selected from the group of user generated music education content consisting of: a lesson unit, a lesson plan, a task, and an assessment. The computer-based method may further comprise the step of: prompting the user to schedule the one or more music education content into a course schedule for at least one student. The computer-based method may further comprise the step of: prompting the user to edit the one or more music education content. The computer-based method may further comprise the step of: allowing a user to preview the one or more selected music education content. The one or more music education content may be one or more multimedia music education content. The copying step may be performed by a drag-and-drop function. The one or more user generated music education content may be selected from the group of user generated music education content consisting of: a blog, a video tutorial, a lesson plan, a best educational practice; and a news feed.

Another embodiment may be a computer-based method for sharing online music education content, the steps comprising: providing a server; wherein the server comprises a server application configured to access a machine readable media; wherein the machine readable media is configured to store one or more music education content; wherein the one or more music education content is one or more copyrighted music education content and one or more user generated music education content; allowing a user to preview the one or more music education content; prompting the user to select the one or more music education content; receiving one or more selections from the user; and copying the one or more music education content to an online classroom based on the one or more selections of the user. The one or more copyrighted music education content may be one or more online textbooks converted from one or more print books. The one or more user generated music education content may be selected from the group of user generated music education content consisting of: a lesson unit, a lesson plan, a task, and an assessment. The computer-based method may further comprise the step of: prompting the user to schedule the one or more music education content into a course schedule for at least one student. The computer-based method may further comprise the step of: prompting the user to edit the one or more music education content. The one or more music education content may be one or more multimedia music education content. The copying step may be performed by a drag-and-drop function. The one or more user generated music education content may be selected from the group of user generated music education content consisting of: a blog, a video tutorial, a lesson plan, a best educational practice; and a news feed.

Another embodiment may be a computer-based method for sharing online music education content, the steps comprising: providing a server; wherein the server comprises a server application configured to access a machine readable media; wherein the machine readable media is configured to store one or more music education content; wherein the one or more music education content are one or more copyrighted music education content and one or more user generated music education content; wherein the one or more copyrighted music education content is one or more online textbooks converted from one or more print books; wherein the one or more user generated music education content is selected from the group of user generated music education content consisting of: a lesson unit, a lesson plan, a task, and an assessment; wherein the one or more user generated music education content is selected from the group of user generated music education content consisting of: a blog, a video tutorial, a lesson plan, a best educational practice; and a news feed; allowing a user to preview the one or more music education content; prompting the user to select the one or more music education content; prompting the user to edit the one or more music education content; receiving one or more selections from the user; copying the one or more music education content to an online classroom using a drag-and-drop function based on the one or more selections of the user; and prompting the user to schedule the one or more music education content on a course schedule for at least one student.

It is an object of the new method to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow chart of one embodiment of the computer-based method for sharing online music education content.

FIG. 2 is block diagram of one embodiment of the computer system.

FIG. 3 is a flow chart of one embodiment of the system for sharing online music education content.

FIG. 4 is a screen shot of one embodiment of the shared content menu of the computer-based method.

FIG. 5 is a screen shot of one embodiment of shared content webpage of the computer-based method for online music education content.

FIG. 6 is a screen shot of one embodiment of the unit detail webpage of the computer-based method for sharing online music education content.

FIG. 7 is a screen shot of one embodiment of the class calendar webpage of the computer-based method for sharing online music education content.

FIG. 8 is a screen shot of one embodiment of the unscheduled lesson plans webpage of the computer-based method for sharing online music education content.

FIG. 9 is a screen shot of one embodiment of the lesson plan selection webpage of the computer-based method for sharing online music education content.

FIG. 10 is a flow diagram of one embodiment of the computer-based method and shows the workflow for a classroom setup.

FIG. 11 is a flow diagram of one embodiment of the computer-based method and shows options for browsing content available to a user.

### DETAILED DESCRIPTION OF ILLUSTRATIVE EMBODIMENTS

In the following detailed description of various embodiments, numerous specific details are set forth in order to provide a thorough understanding of various aspects of the one or more embodiments. However, the embodiments may be practiced without some or all of these specific details. In other instances, well-known methods, procedures, and/or components have not been described in detail so as not to unnecessarily obscure aspects of the embodiments.

While multiple embodiments are disclosed, still other embodiments of the present disclosure will become apparent to those skilled in the art from the following detailed description, which shows and describes illustrative embodiments. As will be realized, the embodiments in this disclosure are capable of modifications in various obvious aspects, all without departing from the spirit and scope of the present disclosure. Accordingly, the graphs, figures, and the detailed descriptions thereof, are to be regarded as illustrative in nature and not restrictive. Also, the reference or non-reference to a particular embodiment shall not be interpreted to limit the scope of the invention.

Before the following embodiments are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

### DEFINITIONS

In the following description, certain terminology is used to describe certain features of one or more embodiments. For example, as used herein, the terms “mobile computing device”, “device”, “computer”, “computing device”, “electronic data processing unit”, “computer system”, or “server” refers to any device that processes information with an integrated circuit chip, comprising, personal computers, mainframe computers, workstations, servers, desktop computers, portable computers, laptop computers, embedded computers, wireless devices including cellular phones, personal digital assistants, tablets, tablet computers, smartphones, portable game players, and hand-held computers.

As used herein, the term “Internet” generally refers to any collection of networks that utilizes standard protocols, whether Ethernet, Token ring, WiFi, asynchronous transfer mode (ATM), Fiber Distributed Data Interface (FDDI), code division multiple access (CDMA), global systems for mobile communications (GSM), long term evolution (LTE), or any combination thereof. The term “website” refers to any document written in a mark-up language including, but not limited to, hypertext mark-up language (HTML) or virtual reality modeling language (VRML), dynamic HTML, extended mark-up language (XML), wireless markup language (WML), or any other computer languages related thereto, as well as to any collection of such documents reachable through one specific Internet Protocol Address or at one specific World Wide Web site, or any document obtainable through any particular Uniform Resource Locator (URL).

As used herein, the terms “webpage”, “page”, “website”, or “site” generally refer to any of the various documents and resources on the World Wide Web, in HTML/XHTML format with hypertext links to enable navigation from one page or section to another, or similar such resources used on the Internet.

As used herein, the term “shared website page” generally refers to any of the various documents and resources on the World Wide Web as stated above with the additional capability for an administrative user to share web-based content to non-administrative users. As used herein, the term “shared website page” can refer to an online classroom or a web-based collaborative portal, blackboard, or whiteboard.

As used herein, the term “copyrighted content” generally refers to any digital content that is protectable under copyright law, such that an exclusive legal right is given to an originator or an assignee to print, publish, perform, film, or record literary, artistic, or musical material.

As used herein, the term “lesson” can refer to any instructive guidance designed to be administered or provided to a student user.

As used herein, the term “task” can refer to any activity that a student user is directed to complete in order to improve their musical proficiency.

As used herein, the term “unit” generally refers to any combination of lessons and tasks, and may further assign particular lessons and tasks of the unit onto specific date or time slots on a calendar for completion.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The present specification discloses a new and improved computer-based method for sharing online content. The computer-based method may comprise the steps: providing a server; allowing a user to preview the one or more music education content; prompting the user to select the one or more music education content; prompting the user to edit the one or more music education content; receiving one or more selections from the user; copying the one or more music education content to an online classroom based on the one or more selections of the user; and prompting the user to schedule the one or more music education content on a course schedule for at least one student. The server may comprise a server application configured to access a machine readable media. The machine readable may store one or more music education content directed to music education. The one or more music education content may be one or more copyrighted content and one or more user generated content.

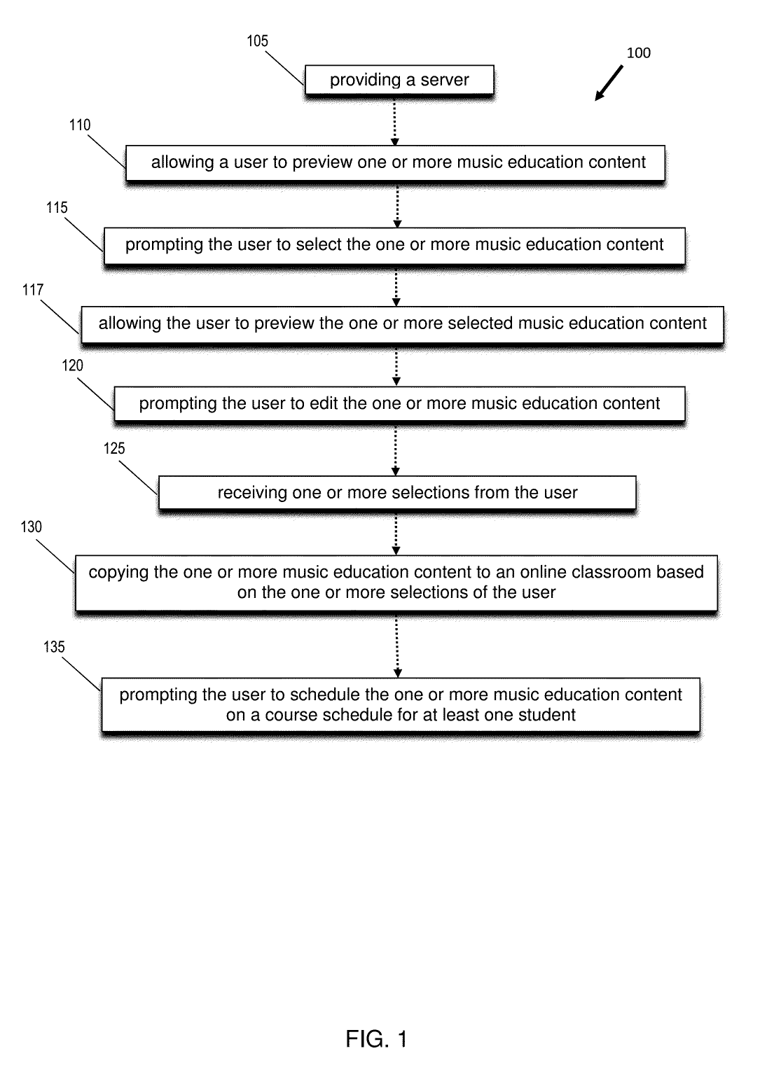

FIG. 1 is a flow chart of one embodiment of the computer-based method for sharing online music education content. As shown in FIG. 1, the computer-based method 100 may comprise the steps: 105, 110, 115, 117, 120, 125, 130, and 135. FIG. 1 shows the first step of one embodiment of the computer-based method 100, which may be providing a server 105. The server may be any computer system or computer program that manages access to a centralized resource or service in a network of computers. Such resources may include files, websites, and webpages. In one embodiment, the server may manage a set of interconnected webpages, which may include a homepage, and may be prepared and maintained as a collection of copyrighted content (e.g., digital rights content) and user generated content. The server may also comprise a server application adapted to prompt a user to enter his or her login information such as a username and password and may be capable of receiving and sending hypertext transfer protocol (HTTP) requests or a web container that generally provides an environment for servlets and Java Server Pages (JSP) to run. Additionally, the server application may gather browser history, internet protocol (IP) location, and other information from the user, and may provide additional webpages. In one embodiment, the server may host a server application such as a website in the Internet.

In various embodiments, the server application may be configured to access machine readable media. As discussed above, the server application may be any set of machine-readable instructions that directs a processor to perform specific steps, processes, or operations disclosed herein. Thus, in various embodiments, the server application may be configured to provide a mechanism for sharing online content such as copyrighted content and user generated content and is generally directed to music education. The server application may also integrate and utilize third party software, which may be a reusable software component developed by programmers or publishers independent other than of the original vendor of the server or server application. The third party software may also be any software application that generates or creates assessments directed to music education and may include questions involving text, audio, and/or video. An example of a third party software application may be Soundation™, which preferably utilizes recording, effects, and virtual instruments.

Regarding the machine readable media, the machine readable media may be any device or component used to store data or information. Examples of such machine readable media may include, without limitation: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of a processor. Examples of optical disks may include, without limitation, Compact Disks (CD) and Digital Versatile Disks (DVD) (e.g., CD-ROM, CD-RW, CD-R, DVD-ROM, DVD-RW, or DVD-R disks). The term “machine readable media” may also refer to various types of recording media capable of being accessed by a computer system via a network or communication link. For example, data may be retrieved over a modem, over the Internet, or over a local area network.

FIG. 1 also shows the next step of an embodiment of the computer-based method 100, which may be allowing a user to preview one or more music education content 110. After the user has accessed the server application, the user may view various content such as copyrighted content (e.g., online textbooks converted from print books) and user generated content (e.g., lesson unit, lesson plans, tasks, assessments). Such previews of copyrighted content and user generated content may comprise user keywords, tags, titles, and samples of the lesson/unit itself. In various embodiments, the user may have access to a brief description of such content or may take a more in-depth preview of the unit, lesson, or task. In one embodiment, the user or teacher user may also preview a completed online classroom or curriculum. Additionally, in other embodiments, the user may utilize copyrighted content, such as digital versions of a hardcopy book, or lessons and tasks created by third parties or other users.

FIG. 1 also shows the next steps of an embodiment of the computer-based method 100, which may be: (1) prompting the user to select the one or more music education content 115; (2) allowing the user to preview the one or more selected music education content 117; and (3) prompting the user to edit the one or more music education content 120. After previewing the content, the server application may prompt the user or teacher to select certain course content by tapping, clicking, copy-and-paste, drag-and-drop, or the like. The selected content may be based on a particular understanding of what will be used on a particular course and may be based on the user's understanding of what units, lessons, and tasks may be helpful in increasing the student's music ability. As a result, the server application may receive one or more selections from the user, as shown in the next step 125 in FIG. 1. Once selected, the server application may prompt the user or teacher to edit or change the selected content such as changing the title, overview, description, lesson plan, tasks, curriculum, syllabi, and assessments for each content. In various embodiments, the user may also preview the selected music education content before sending his or her selections to the server application.

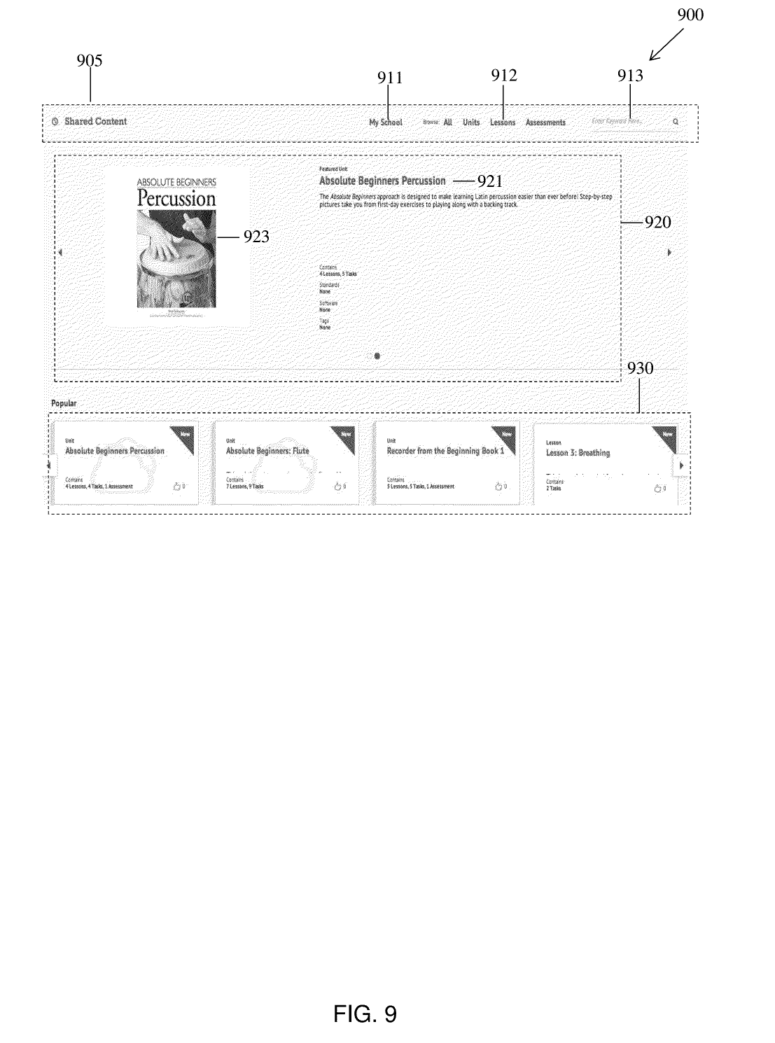

FIG. 1 shows the next step of one embodiment of the computer-based method 100, which may be copying by the server application the one or more music education content to an online classroom based on the one or more selections of the user 130. As discussed above, the server application may be configured to receive content selections from the user or teacher and each content selection may be tailored to a particular student. As a result, the online classroom generally provides a unique experience that may be focused on each student's competencies. The online classroom may be accessed by visiting a webpage or by having the student use a login account to select the desired classroom. As such, the user may schedule content on a course schedule for each student, and this may be done by various mechanisms such as clicking, selection, and drag-and-drop desired content onto a calendar, as shown in FIG. 9. Each student may have their own customized calendar, as configured by the user, and the student user may have the ability to make changes to the calendar on their own. In an embodiment, the user or teacher may also edit the content such as adding or removing lessons and tasks from a specified unit. Additionally, lessons and tasks within specified units may be edited by the user to further customize the unit. Although FIG. 1 only shows seven steps, any number of steps may be performed.

In various embodiments, the user, teacher, or student may have access to resources such as blogs, video tutorials, lesson plans, best practices, and news feeds. This may be done in order to assist teachers and users with current material or to improve the online classroom learning experience.

In another embodiment, a user may have access to a server and may be able to preview user generated content, which comprises units, lessons, and tasks. The user may then select desired content and assign that content to an online classroom. The online classroom may then be populated by students. Once the students have access to the content, the students may use the content and progress through the units, lessons, and tasks. The user or teacher then may monitor the progress of each of the student by viewing what units, lessons, and tasks the student has completed, and information regarding time of completion.

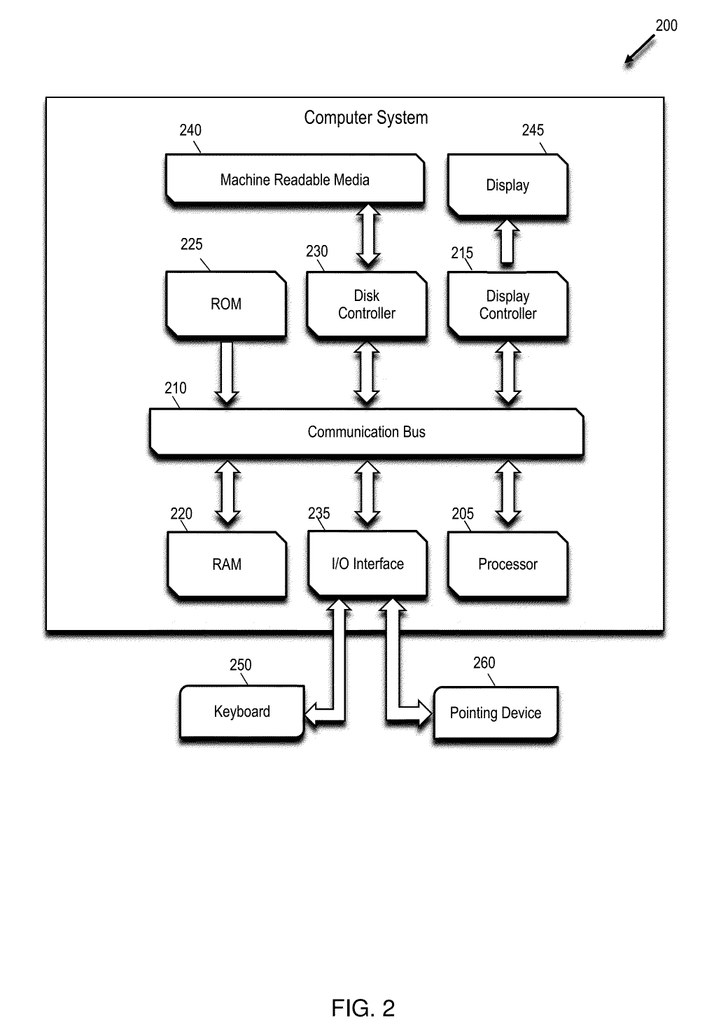

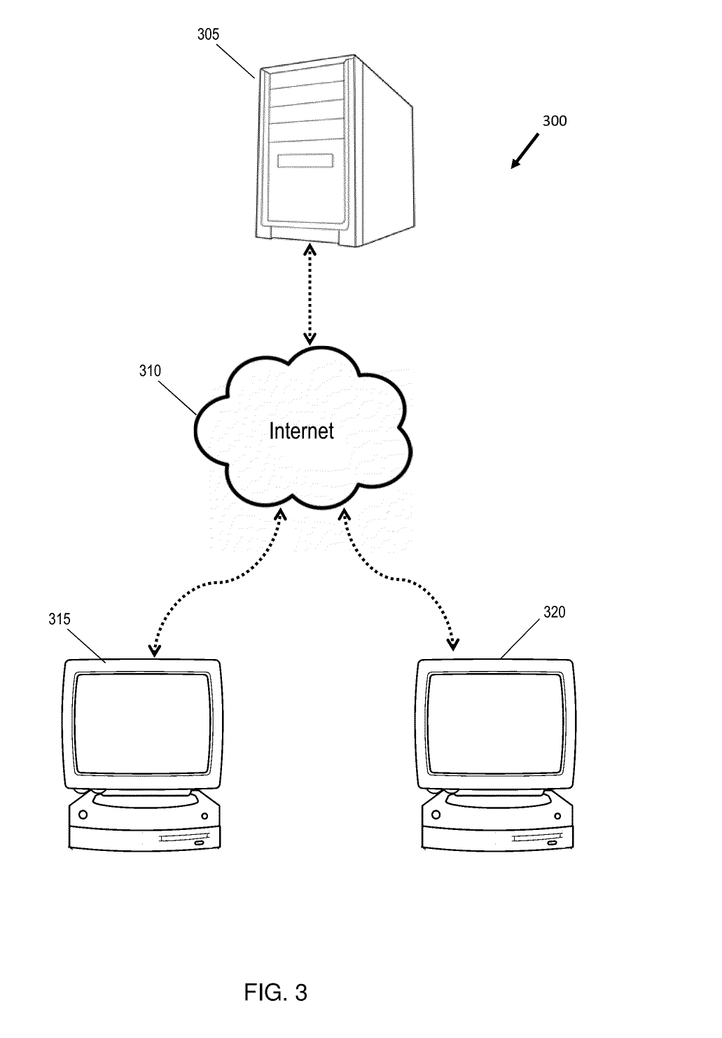

FIG. 2 is block diagram of one embodiment of the computer system. As shown in FIG. 2, one embodiment of the computer system 200 may comprise: a processor 205, communication bus 210, display controller 215, random access memory (RAM) 220, read only memory (ROM) 225, disk controller 230, input/output interface (I/O interface) 235, machine readable media 240, display 245, and one or more input devices, wherein the input devices may include: a keyboard 250, pointing device 260 (e.g., mouse). In one embodiment, the computer system 200 may be a server or a personal computer that comprises a processor 205 coupled to a communication bus 210. The communication bus 210 may also be coupled to other electronic hardware, including without limitation, a display controller 215, RAM 220, ROM 225, disk controller 230, and I/O interface 235. The disk controller 230 may be used to control the machine readable media 240, which may be a hard drive, solid state drive, and/or optical disk drive. Additionally, the machine readable media 240 may be another form of storage device such as random access memory or flash memory. The display controller 215 may be connected to a display 245 such as a cathode ray tube (CRT), liquid crystal display (LCD), projection system, or touchscreen. The I/O interface 235 may be connected to various input devices such as a keyboard 450, pointing device 260, and/or touchscreen. In additional embodiments, the computer system 400 may also comprise a network controller card connected through a network (shown in FIG. 3) such as the Internet or along an Intranet.

The processor 205 may be used to execute a set of computer readable instructions and further to execute a software application, server application, or computer program such as the server application described herein. The computer readable instructions and server application may comprise instructions that cause the processor 205 to perform the above-disclosed methods and processes when the instructions are executed by the processor 205. In other various embodiments, the computer readable instructions or application may be tangibly embodied in the memory of the computer system 200 such as the RAM 220 or ROM 225, as shown in FIG. 2, or on a machine readable media, such as a magnetic, optical or solid-state digital storage medium.

FIG. 3 is a flow chart of one embodiment of the system for sharing online music education content. As shown in FIG. 3, one embodiment of the system 300 may comprise: a server 305, Internet 310, and computer systems 315, 320. As discussed above, the server 305 may be a computer system or computer program that manages access to a centralized resource or service in a network and may act as a repository for files, documents, and assessments that may be created by the server application. The Internet 310 may be a computer network consisting of a worldwide network of computer networks that use the TCP/IP network protocols to facilitate data transmission and exchange. The computer systems 315, 320 may be a device designed for individual use, such as a music educator or a student at home or school, for sharing online content.

FIG. 3 also shows how a user may use an embodiment of the system to access the server to share content based on the computer-based method 100. Specifically, a user such as a teacher may use his or her computer system 315 (e.g., laptop, desktop, smartphone, tablet computer) and access the server 305 via the Internet 310. This may be accomplished by performing a login on the website of the server 305. Once the user logs himself or herself into the server 305, the user, teacher, or educator may have access to the server application. The user may then use the server application to preview content. As discussed above, the content is generally directed to music education and may be based on copyrighted content and user generated content. Examples of copyrighted content may be online textbooks converted from print books. Examples of user generated content may be lesson units, lesson plans, tasks, and assessments. The server application may then prompt the user to select content for editing and copying. After the user selects certain content, the server application receives the selections from the user, and the server application may copy the content to an online classroom. This may be performed by using a drag-and-drop function. Finally, the user or teacher may schedule the content on a course schedule for one or more students. Although FIG. 3 shows the system 300 with three different devices (e.g., server 305 and computer systems 315, 320), the system 300 may function with any number of devices.

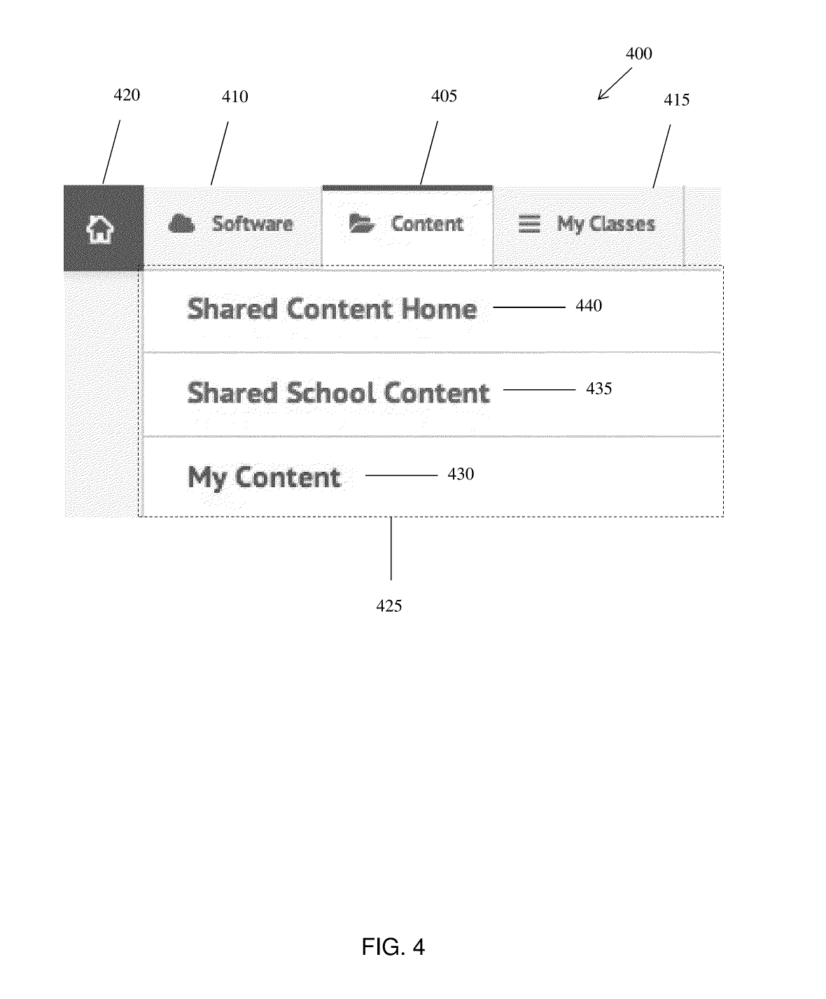

FIG. 4 is a screen shot of one embodiment of the shared content menu of the computer-based method. As shown in FIG. 4, one embodiment of the shared content menu 400 may comprise: a content tab 405, software tab 410, my classes tab 415, a home button 420; and a sub-menu 425 of the content tab 405. The my classes tab 415 may provide the user with access to online classes or classrooms for editing the course content and curriculum. The content tab 405 may provide the user with access and previews to both the user generated content and copyrighted content. The home button 420 may provide the user with access to the home page.

FIG. 4 also shows that the sub-menu may comprise a shared content home tab 440, shared school content tab 435, and my content tab 430. The shared content home tab 440 may provide the user with previews and access to currently shared content. The shared school content tab 435 may provide the user with previews and access to currently shared content for a particular online course, school, or classroom. The my content tab 430 may provide the user with access to content which may be previewed, accessed, and shared for current and future classrooms.

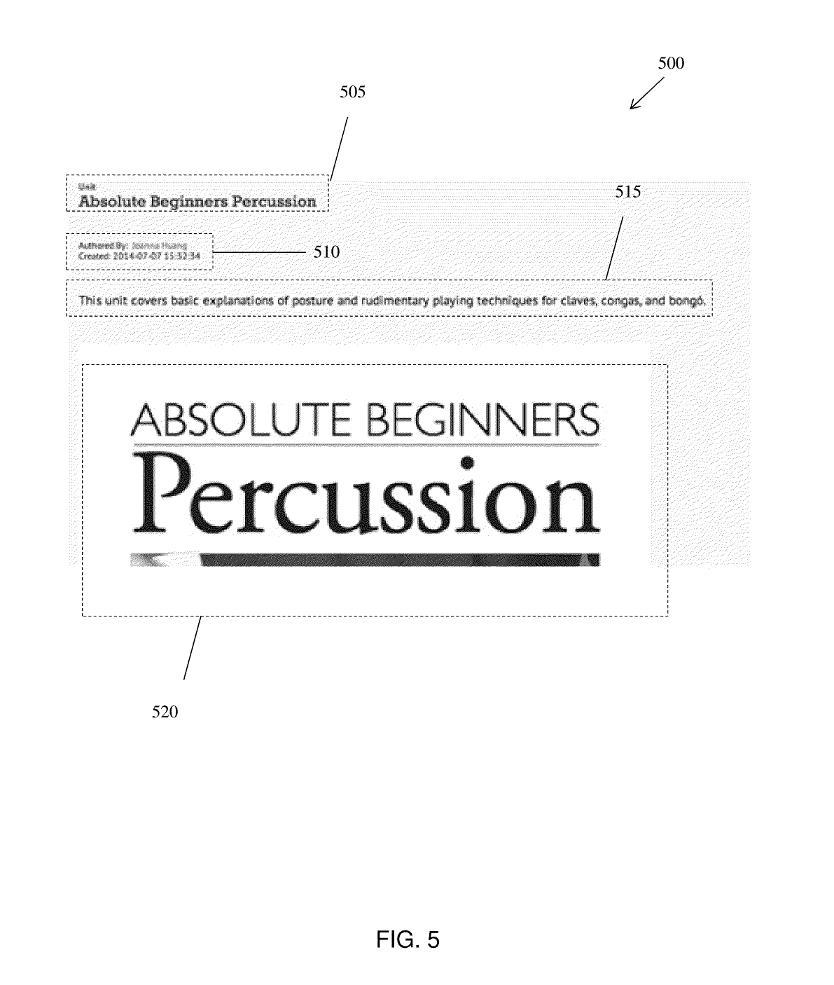

FIG. 5 is a screen shot of one embodiment of shared content webpage of the computer-based method for online music education content. As shown in FIG. 5, one embodiment of shared content webpage 500 may comprise: a title 505, author 510, brief description 515, and banner 520. The title 505 may be the title of the content and may be used to identify or classify the shared content and/or course name. The author 510 may be the name of the author of the particular content and may comprise data regarding the author and date of publication or creation. The brief description 515 may be a description or overview of that content, and may comprise the recommended instrument that the shared content relates to, the recommended skill level, and a brief description of what techniques are taught. The banner 520 may be artwork or simple typeface which may quickly or easily allow the user to identify the shared content.

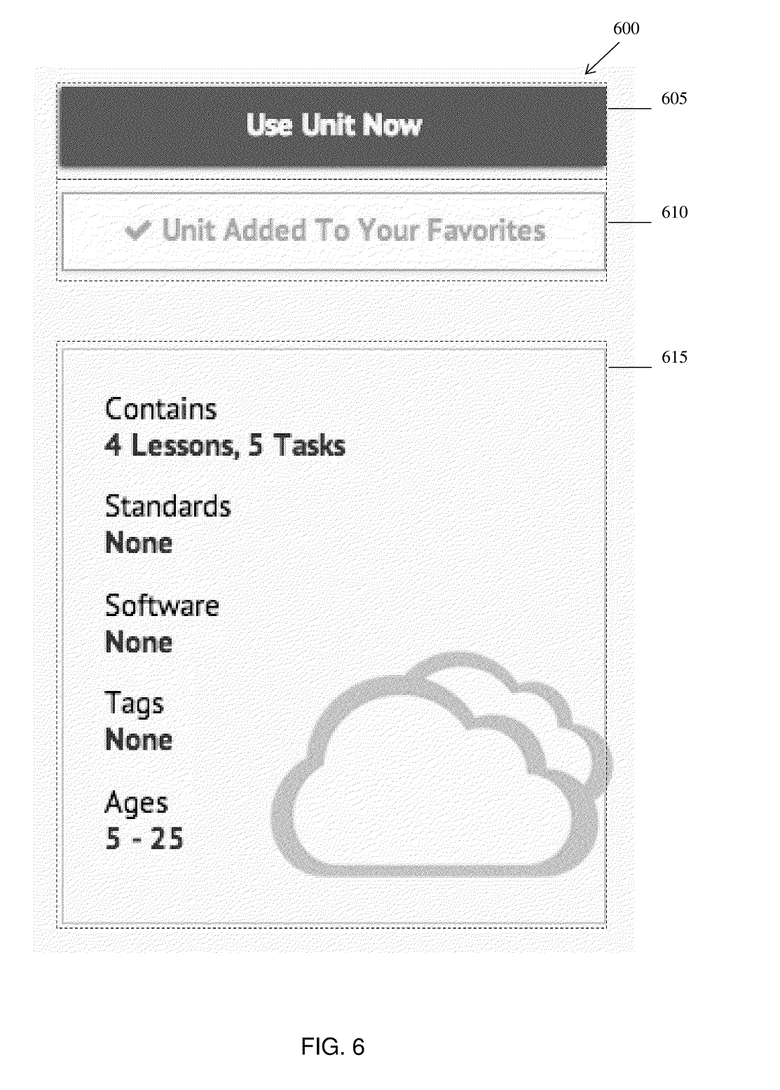

FIG. 6 is a screen shot of one embodiment of the unit detail webpage of the computer-based method for sharing online music education content. As shown in FIG. 6, one embodiment of the unit webpage 600 may comprise: a “Use Unit Now” button 605, a status bar 610, and a unit information table 615. When the “Use Unit Now” button 605 is selected, the unit may be launched and followed with on screen directions. The “Use Unit Now” button 605 may also be clicked, selected, or tapped in order to have the unit added to a shared website page. The status bar 610 may show the status of the unit and may indicate that the unit may be pre-loaded or is on the favorite's list. The unit information table 615 may provide information regarding the unit and may comprise information about the unit, including without limitation, information relating to the number of lessons and tasks that the student would be asked to view and perform, the standards may indicate what the goal is, the software may indicate what software is required to run the unit, the tags may be associated with the unit to allow for easier sorting or searching, and the age range may indicate for what age range of people the unit is suitable.

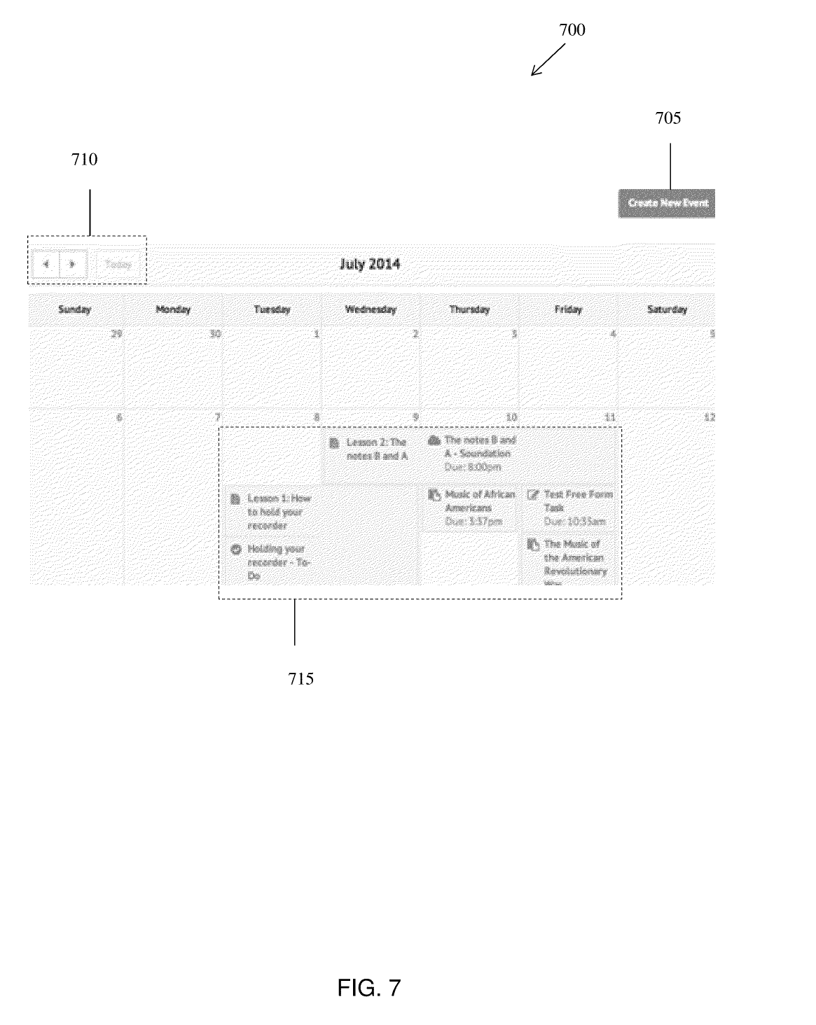

The unit webpage 600 may be used by a user as an overview of the unit in order to quickly determine suitability for a selected purpose. A unit may comprise a collection of lessons and tasks which may be selected and grouped together to form a coherent strategy for teaching how to play an instrument. The unit may be custom designed for particular students by teacher users. Once used, the unit may be added to a calendar so that both the teacher and the student user can keep track of unit progress, as shown in FIG. 7.

FIG. 7 is a screen shot of one embodiment of the class calendar webpage of the computer-based method for sharing online music education content. As shown in FIG. 7, one embodiment of the class calendar webpage 700 may comprise a “Create New Event” button 705, a date selection tool 710, and lesson appointments 715. The class calendar webpage 700 may be used to plan out a student's practice and testing schedule. Additionally, in the event of a time conflict, the class calendar webpage 700 may be able to and easily show the time conflict. A user may use the “Create New Event” button 705 to add more lessons, units, or other time commitments to the class calendar webpage 700. A user may navigate through the class calendar webpage 700 by using the date selection tool 710, which may be used to browse different months, weeks, or days and a “Today” button may be used to jump to the current day to see what the student user should do that day. The lesson appointments 715 may be used to show a user when a lesson, activity, or assessment should be performed and on a particular day. To access a lesson, a user may select the lesson on the calendar and the lesson may begin automatically, or after a summary of lesson screen. The class calendar webpage 700 may be used in concert with various other webpages associated with the content sharing method to allow for drag and drop functionality of various units and/or lessons directly onto a calendar.

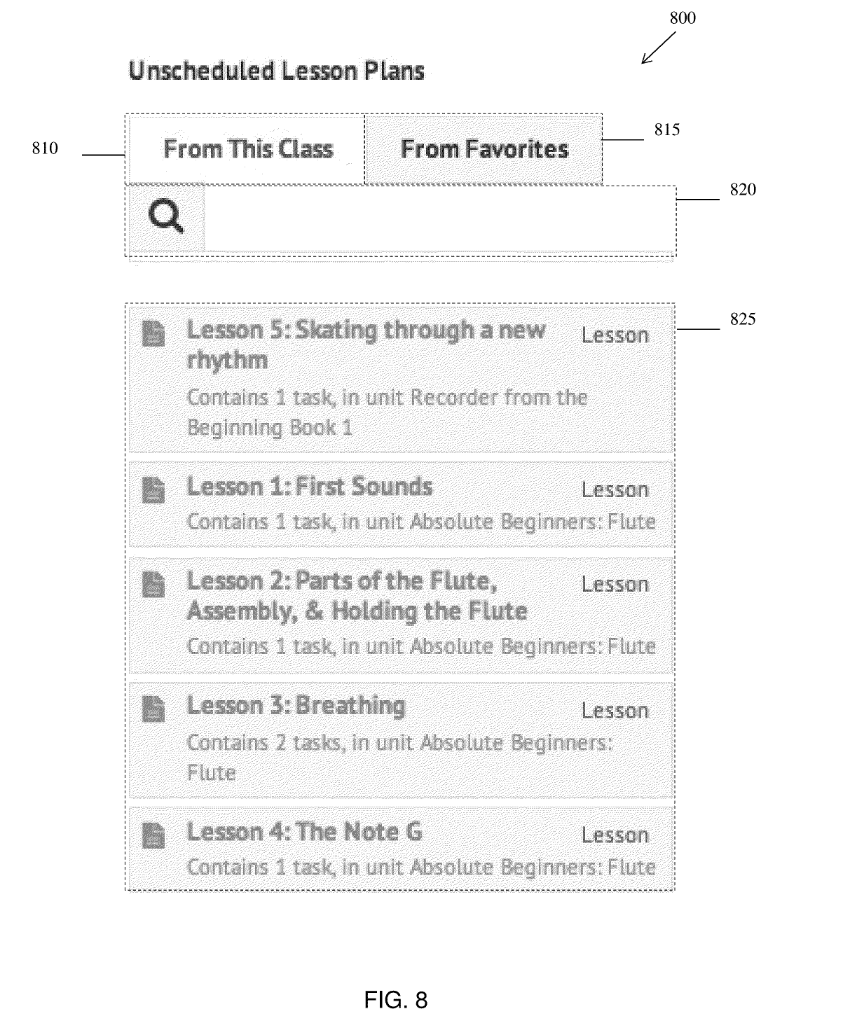

FIG. 8 is a screen shot of one embodiment of the unscheduled lesson plans webpage of the computer-based method for sharing online music education content. As shown in FIG. 8, one embodiment of the unscheduled lesson plans webpage 800 may comprise: a class menu 810; favorites menu 815, a search bar 820, and listing 825. The class menu 810 may provide the user with information with unscheduled lesson plans which may be added to a particular class. The favorites menu 815 may provide information regarding lesson plans which are most commonly used by the user or teacher or which may be recommended by the server application. The search bar 820 may be used to find any specific lesson that the user wishes to include but has not scheduled onto a specific class. The listing 825 may be used to show one or more lesson plans which may be added to a course schedule. In various embodiments, a lesson may be assigned from the unscheduled lesson plan webpage 800 onto a class calendar through a drag and drop, or other similar type of functionality.

FIG. 9 is a screen shot of one embodiment of the lesson plan selection webpage of the computer-based method for sharing online music education content. As shown in FIG. 9, one embodiment of the lesson plan selection webpage 900 may comprise a shared content menu 905, an information table 920, image 923, and a lesson banner 930. As further shown in FIG. 9, the shared content menu 905 may further comprise a “my school” button 911, a browsing menu 912, and a search bar 913. The my school button 911 may provide content and course information on a particular online classroom. The browsing menu 912 may allow the user or teacher to browse various available lessons. The search bar 913 may provide a search functionality for the webpage. The information table 920 may provide information about a particular lesson and may comprise a title of the lesson 921, brief description, image 23, and any additional information about the lesson.

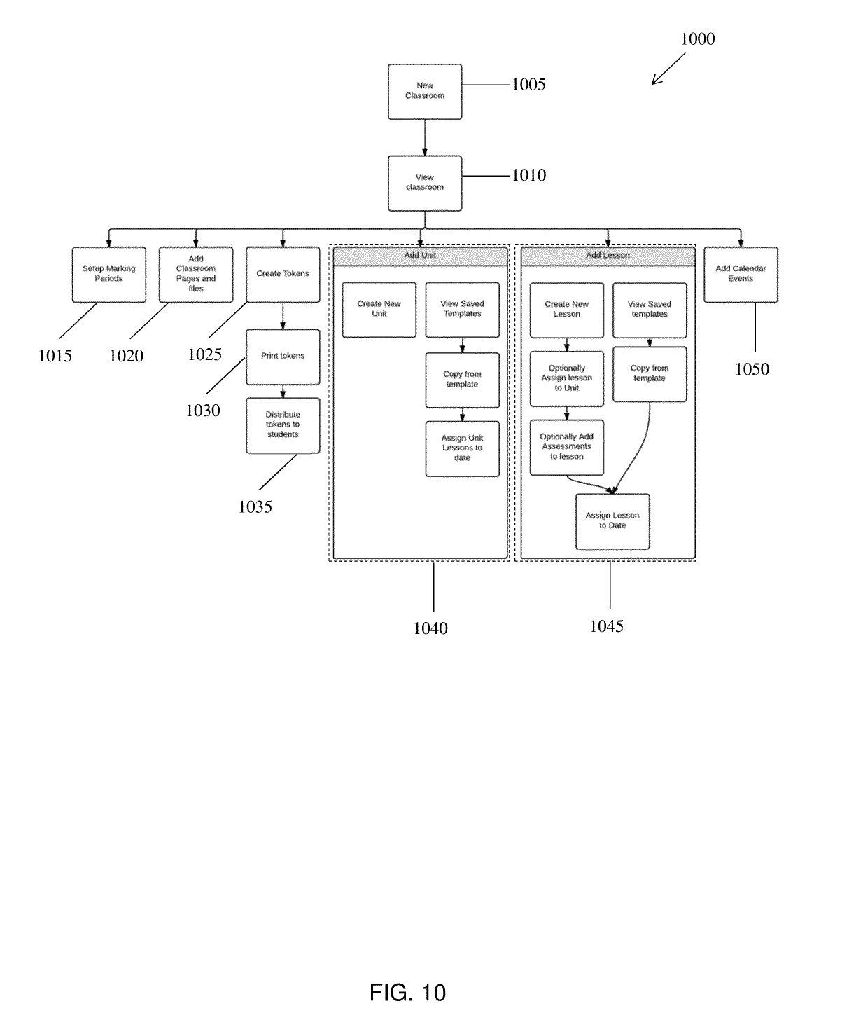

FIG. 10 is a flow diagram of one embodiment of the computer-based method and shows the workflow for a classroom setup. As shown in FIG. 10, one embodiment of the computer-based method 1000 may comprise the steps of: 1005, 1010, 1015, 1020, 1025, 1030, 1035, 1040, 1045, and 1050. FIG. 10 shows that a user may start creating a new classroom 1005 by first viewing the classroom 1010. While viewing the classroom 1010, the user may be given various options, comprising setting up marking periods 1015; adding classroom pages and files 1020; creating tokens 1025, printing tokens 1030, and distributing tokens to students 1035; adding units 1040; adding lessons 1045; and adding calendar events 1050. Specifically, the user may setup marking periods 1015 by selecting various time periods on a calendar that indicate when a student user will be graded or evaluated. The user or teacher may also add classroom pages and files 1020 to allow other users to access resources that the first user wants the other users to see. These pages and files may include information, instructions, updates, and/or homework. The user may also create tokens 1025, which may act as a key or pass to access the classroom. The user may print the tokens 1030 onto paper or by using a printer, and then distribute the tokens to students 1035 that the user desires to be in the classroom. In various embodiments, the user may also add a unit 1040 to the classroom, and the user may have several options, including creating a new unit from scratch or viewing saved templates, copying from the templates, and assigning unit lessons to dates on a calendar. Similarly, the user may add a lesson 1045 by creating a new lesson, assigning the lesson to a unit, adding assignments to the lesson, and assigning the lesson to a date. Alternatively, a user may add a lesson 1045 by viewing saved lesson templates, copying from templates, and assigning lessons to dates. The user may also add calendar events 1050 that may be beneficial to the students learning or enrichment. For example, the user may add a calendar date event 1050 for a particular music festival that the user wishes to encourage the student users to attend.

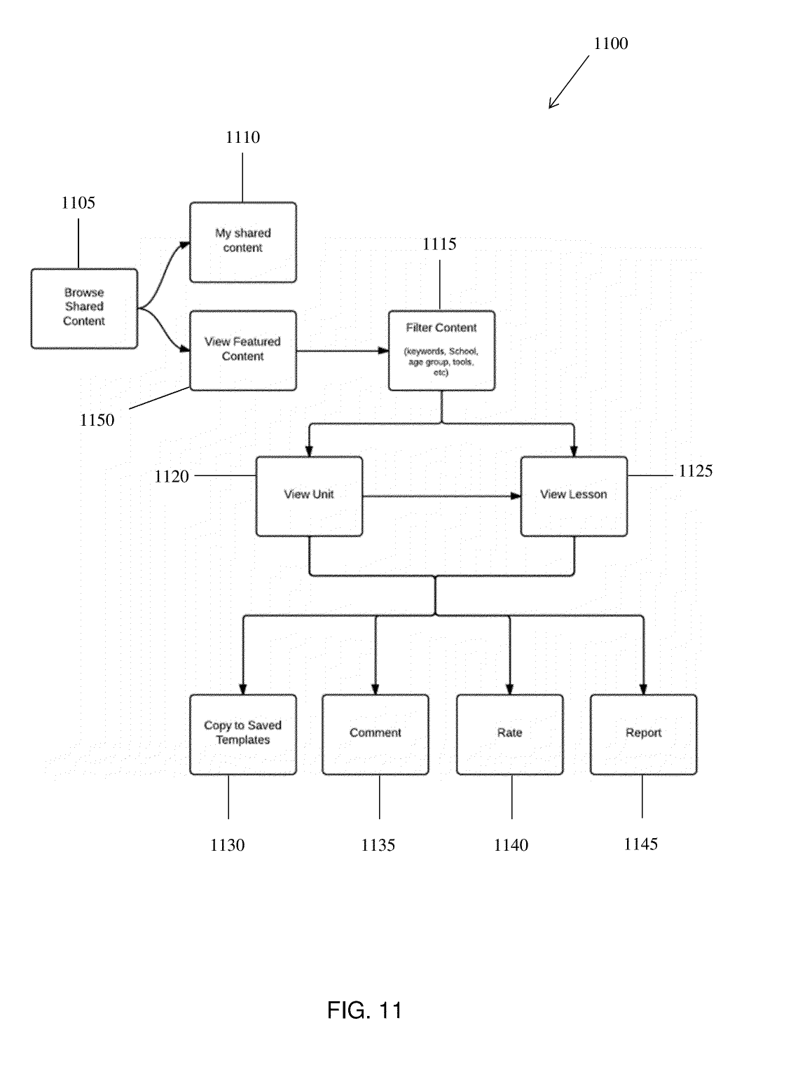

FIG. 11 is a flow diagram of one embodiment of the computer-based method and shows options for browsing content available to a user. As shown in FIG. 11, one embodiment of the computer-based method 1100 may comprise the steps of: 1105, 1110, 1115, 1120, 1125, 1130, 1135, 1140, 1145, and 1150. FIG. 11 shows that a user or teacher may browse shared content 1105, which may be done by either viewing the user's or teacher's shared content” 1110 and/or viewing the course's featured content 1150. The shared content 1110 may be content that the user has used, added to favorites, bookmarked, or otherwise marked for use later use. Once a user has viewed the shared content, the user may filter the content 1115 by keywords, age group appropriateness, tools to be used, or any other parameter which may be used to narrow the search results. The user may then view units 1120 or view lessons 1125, which may allow the user to decide which unit to view first. Thereafter, the user may view lessons 1125 found within the units. The user may then evaluate the units and lessons by simply copying the selected units to saved templates 1130 for later use and may comment 1135 to allow other users to know the user's impressions, grading rate 1140 to provide some metric for the quality, or report 1145 to allow those who maintain the database to be aware that there may be problems with the unit or lesson. When taken together, this ability may be used to save, view, and provide feedback may help to improve the functionality of the content sharing method by giving users more pieces of information to consider.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. This disclosure should therefore not be limited by the above described embodiment, method, and examples, but by all embodiments and methods within the scope and spirit of the disclosure as claimed.

The foregoing description of the preferred embodiment has been presented for the purposes of illustration and description. While multiple embodiments are disclosed, still other embodiments will become apparent to those skilled in the art from the above detailed description, which shows and describes illustrative embodiments. As will be realized, the embodiments are capable of modifications in various obvious aspects, all without departing from the spirit and scope. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope. It is intended that the scope not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for sharing online music education content, the steps comprising:
providing a server;
wherein said server comprises a server application configured to access a machine readable media;
wherein said machine readable media is configured to store one or more music education content;
allowing a user to preview said one or more music education content;
prompting said user to select said one or more music education content;
receiving one or more selections from said user; and
copying said one or more music education content to an online classroom based on said one or more selections of said user.

2. The computer-based method of claim 1, wherein said one or more music education content is one or more copyrighted music education content.

3. The computer-based method of claim 3, wherein said one or more copyrighted music education content is one or more online textbooks converted from one or more print books.

4. The computer-based method of claim 1, wherein said one or more music education content is one or more user generated music education content.

5. The computer-based method of claim 5, wherein said one or more user generated music education content is selected from the group of user generated music education content consisting of: a lesson unit, a lesson plan, a task, and an assessment.

6. The computer-based method of claim 1, further comprising the step of:
prompting said user to schedule said one or more music education content into a course schedule for at least one student.

7. The computer-based method of claim 1, further comprising the step of:
prompting said user to edit said one or more music education content.

8. The computer-based method of claim 1, further comprising the step of
allowing a user to preview said one or more selected music education content.

9. The computer-based method of claim 1, wherein said one or more music education content is one or more multimedia music education content.

10. The computer-based method of claim 1, wherein said copying step is performed by a drag-and-drop function.

11. The computer-based method of claim 1, wherein said one or more user generated music education content is selected from the group of user generated music education content consisting of: a blog, a video tutorial, a lesson plan, a best educational practice; and a news feed.

12. A computer-based method for sharing online music education content, the steps comprising:
providing a server;
wherein said server comprises a server application configured to access a machine readable media;
wherein said machine readable media is configured to store one or more music education content;
wherein said one or more music education content is one or more copyrighted music education content and one or more user generated music education content;
allowing a user to preview said one or more music education content;
prompting said user to select said one or more music education content;
receiving one or more selections from said user; and
copying said one or more music education content to an online classroom based on said one or more selections of said user.

13. The computer-based method of claim 12, wherein said one or more copyrighted music education content is one or more online textbooks converted from one or more print books.

14. The computer-based method of claim 12, wherein said one or more user generated music education content is selected from the group of user generated music education content consisting of: a lesson unit, a lesson plan, a task, and an assessment.

15. The computer-based method of claim 12, further comprising the step of:
prompting said user to schedule said one or more music education content into a course schedule for at least one student.

16. The computer-based method of claim 12, further comprising the step of:
prompting said user to edit said one or more music education content.

17. The computer-based method of claim 12, wherein said one or more music education content is one or more multimedia music education content.

18. The computer-based method of claim 12, wherein said copying step is performed by a drag-and-drop function.

19. The computer-based method of claim 12, wherein said one or more user generated music education content is selected from the group of user generated music education content consisting of: a blog, a video tutorial, a lesson plan, a best educational practice; and a news feed.

20. A computer-based method for sharing online music education content, the steps comprising:
providing a server;
wherein said server comprises a server application configured to access a machine readable media;
wherein said machine readable media is configured to store one or more music education content;
wherein said one or more music education content are one or more copyrighted music education content and one or more user generated music education content;
wherein said one or more copyrighted music education content is one or more online textbooks converted from one or more print books;
wherein said one or more user generated music education content is selected from the group of user generated music education content consisting of: a lesson unit, a lesson plan, a task, and an assessment;
wherein said one or more user generated music education content is selected from the group of user generated music education content consisting of: a blog, a video tutorial, a lesson plan, a best educational practice; and a news feed;
allowing a user to preview said one or more music education content;
prompting said user to select said one or more music education content;
prompting said user to edit said one or more music education content;
receiving one or more selections from said user;
copying said one or more music education content to an online classroom using a drag-and-drop function based on said one or more selections of said user; and
prompting said user to schedule said one or more music education content on a course schedule for at least one student.
